(19) United States
(12) Patent Application Publication
(10) Pub. No.: US 2020/0282976 A1
(43) Pub. Date: Sep. 10, 2020

(54) VEHICLE CONTROL DEVICE, INFORMATION PROVIDING DEVICE, INFORMATION PROVIDING SYSTEM, VEHICLE CONTROL METHOD, INFORMATION PROVIDING METHOD, AND STORAGE MEDIUM

(71) Applicant: HONDA MOTOR CO., LTD., Tokyo (JP)

(72) Inventors: Yasushi Shoda, Wako-shi (JP); Junpei Noguchi, Wako-shi (JP); Yuki Hara, Wako-shi (JP); Ryoma Taguchi, Tokyo (JP); Yuta Takada, Tokyo (JP)

(21) Appl. No.: 16/795,616

(22) Filed: Feb. 20, 2020

(30) Foreign Application Priority Data
Mar. 6, 2019 (JP) 2019-040967

(51) Int. Cl. B60W 30/06; G05D 1/00; G08G 1/14; B60W 10/04; B60W 10/18; B60W 10/20

(52) U.S. Cl. CPC B60W 30/06; G05D 1/0088; G08G 1/146; B60W 10/04; B60W 2710/20; B60W 10/20; G05D 2201/0213; B60W 2720/10; B60W 10/18

(57) ABSTRACT

A vehicle control device includes a driving controller configured to control steering and acceleration or deceleration of the vehicle on the basis of a vicinity situation recognized by a vicinity situation recognizer, a first determiner configured to determine whether the vehicle may enter a specific parking facility in which vehicles autonomously park, a second determiner configured to determine whether the vehicle is a vehicle that can enter the specific parking facility, and an information provider configured to notify an occupant of the vehicle that entrance to the specific parking facility is inappropriate before the vehicle enters the specific parking facility when it is determined that the vehicle may enter the specific parking facility and it is determined that the vehicle is a vehicle that cannot enter the specific parking facility.

### CROSS-REFERENCE TO RELATED APPLICATION

Priority is claimed on Japanese Patent Application No. 2019-040967, filed Mar. 6, 2019, the content of which is incorporated herein by reference.

### BACKGROUND

### Field

The present invention relates to a vehicle control device, an information providing device, an information providing system, a vehicle control method, an information providing method, and a storage medium.

### Description of Related Art

In recent years, research on automatic controlling of vehicles has been conducted. In automatic valet parking using this technology, a parking management device which, if an exit request signal that requests an exit from parking is received, creates an exit traveling route from a parking position of a vehicle which was requested to exit to a boarding area and transmits information of the exit traveling route to the vehicle has been disclosed (Japanese Unexamined Patent Application, First Publication No. 2018-97536)

However, the conventional technology described above does not disclose processing when a vehicle enters a parking lot. For this reason, an inappropriate vehicle may enter a facility of a parking lot or a user may attempt to cause an inappropriate vehicle to enter the facility of a parking lot.

### SUMMARY

The present invention has been made in view of such circumstances, and an object thereof is to provide a vehicle control device, an information providing device, an information providing system, a vehicle control method, an information providing method, and a storage medium which can allow a user to recognize in advance that a predetermined parking lot is not available.

A vehicle control device, an information providing device, an information providing system, a vehicle control method, an information providing method, and a storage medium have adopted the following configuration.

(1): A vehicle control device according to one aspect is a vehicle control device which includes a vicinity situation recognizer configured to recognize a vicinity situation of a vehicle, a driving controller configured to control steering and acceleration or deceleration of the vehicle on the basis of the vicinity situation recognized by the vicinity situation recognizer, a first determiner configured to determine whether the vehicle may enter a specific parking facility in which vehicles autonomously park, a second determiner configured to determine whether the vehicle is a vehicle that can enter the specific parking facility, and an information provider configured to notify an occupant of the vehicle that entrance to the specific parking facility is inappropriate before the vehicle enters the specific parking facility when the first determiner determines that the vehicle may enter the specific parking facility and the second determiner determines that the vehicle is a vehicle that cannot enter the specific parking facility.

(2) In the aspect of (1) described above, when a facility having the specific parking facility is a facility provided with a getting-off area at which the occupant of the vehicle gets off the vehicle after the vehicle passes through an entrance reference point that is a reference of entrance, the information provider performs the notification before the vehicle passes through the entrance reference point.

(3): In the aspect of (1) or (2) described above, when a facility having the specific parking facility is a facility in which the vehicle can reach a getting-off area at which the occupant of the vehicle gets off the vehicle without passing through an entrance reference point that is a reference of entrance, the information provider performs the notification when the vehicle has reached or before reaching the getting-off area.

(4): In the aspect of any one of (1) to (3) described above, the first determiner is configured to determine whether a facility having the specific parking facility is a facility provided with a getting-off area at which the occupant of the vehicle gets off the vehicle after the vehicle passes through an entrance reference point that is a reference of entrance, and whether the facility having the specific parking facility is the facility in which the vehicle can reach the getting-off area at which the occupant of the vehicle gets off the vehicle without passing through the entrance reference point that is a reference of entrance, and the information provider is configured to change a timing for performing the notification on the basis of a result of the determination performed by the first determiner.

(5): In the aspect of any one of (1) to (4) described above, the second determiner is configured to determine a vehicle that tows an object, a vehicle that does not have a function of controlling the steering and acceleration or deceleration thereof, a vehicle whose minimum ground clearance is equal to or less than a set minimum ground clearance, or a vehicle which has different outer diameters of left and right tires thereof as a vehicle which cannot enter the specific parking facility.

(6): An information providing device according to another aspect includes a first determiner configured to determine whether a vehicle controlling steering and acceleration or deceleration of the vehicle may enter a specific parking facility in which vehicles autonomously park on the basis of a vicinity situation recognized by a vicinity situation recognizer that is configured to recognize the vicinity situation of the vehicle, a second determiner configured to determine whether the vehicle is a vehicle that can enter the specific parking facility, and an information provider configured to notify an occupant of the vehicle that entrance to the specific parking facility is inappropriate before the vehicle enters the specific parking facility when the first determiner determines that the vehicle may enter the specific parking facility and the second determiner determines that the vehicle is a vehicle that cannot enter the specific parking facility.

(7): In the aspect of (6) described above, when a facility having the specific parking facility is a facility provided with a getting-off area at which the occupant of a vehicle gets off the vehicle after the vehicle passes through an entrance reference point that is a reference of entrance, the information provider performs the notification before the vehicle passes through the entrance reference point.

(8): In the aspect of (6) or (7) described above, when a facility having the specific parking facility is a facility in which a vehicle can reach a getting-off area at which the occupant of the vehicle gets off the vehicle without passing through an entrance reference point that is a reference of entrance, the information provider performs the notification when the vehicle has reached or before reaching the getting-off area.

(9): In the aspect of any one of (6) to (8) described above, the first determiner is configured to determine that a facility having the specific parking facility is a facility provided with a getting-off area at which the occupant of a vehicle gets off the vehicle after the vehicle passes through an entrance reference point that is a reference of entrance, or that the facility having the specific parking facility is a facility in which a vehicle can reach a getting-off area at which the occupant of the vehicle gets off the vehicle without passing through the entrance reference point that is a reference of entrance, and the information provider is configured to change a timing for performing the notification on the basis of a result of the determination performed by the first determiner.

(10): An information providing system according to still another aspect includes a terminal device which includes a terminal-side determiner configured to determine whether a vehicle is a vehicle that cannot enter a specific parking facility in accordance with a request from a vehicle control device, and a terminal-side provider configured to provide a result of the determination performed by the terminal-side determiner to the vehicle control device when the terminal-side determiner determines that the vehicle is a vehicle that cannot enter the specific parking facility, a vehicle control device that includes; a vicinity situation recognizer configured to recognize a vicinity situation of a vehicle, a driving controller configured to control steering and acceleration or deceleration of the vehicle on the basis of the vicinity situation recognized by the vicinity situation recognizer, a vehicle-side determiner configured to determines whether the vehicle may enter the specific parking facility in which vehicles autonomously park, and, when it is determined that the vehicle may enter the specific parking facility, to request the terminal device to determine whether the vehicle is a vehicle that can enter the specific parking facility, and a vehicle-side provider configured to notify an occupant of the vehicle that entrance to the specific parking facility is inappropriate before the vehicle enters the specific parking facility when it is determined that the vehicle is a vehicle that cannot enter the specific parking facility on the basis of a result of determination provided by the terminal-side provider in accordance with the request.

(11): In the aspect of (10) described above, when a facility having the specific parking facility is a facility provided with an getting-off area at which the occupant of a vehicle gets off the vehicle after the vehicle passes through an entrance reference point that is a reference of entrance, the vehicle-side provider performs the notification before the vehicle passes through the entrance reference point.

(12): In the aspect of (10) or (11) described above, when a facility having the specific parking facility is a facility in which a vehicle can reach a getting-off area at which the occupant of the vehicle gets off the vehicle without passing through an entrance reference point that is a reference of entrance, the vehicle-side provider performs the notification when the vehicle has reached or before reaching the getting-off area.

(13): In the aspect of any one of (10) to (12) described above, the vehicle-side determiner is configured to determine that a facility having the specific parking facility is a facility provided with a getting-off area at which the occupant of a vehicle gets off the vehicle after the vehicle passes through an entrance reference point that is a reference of entrance, or that the facility having the specific parking facility is a facility in which a vehicle can reach a getting-off area at which the occupant of the vehicle gets off the vehicle without passing through the entrance reference point that is a reference of entrance, and the vehicle-side provider is configured to change a timing for performing the notification on the basis of a result of the determination performed by the vehicle-side determiner.

(14): A vehicle control method according to still another aspect includes, by one or more control devices, recognizing a vicinity situation of a vehicle, controlling steering and acceleration or deceleration of the vehicle on the basis of the recognized vicinity situation, determining whether the vehicle may enter a specific parking facility in which vehicles autonomously park, determining whether the vehicle is a vehicle that can enter the specific parking facility, and notifying an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

(15): A non-transitory computer-readable storage medium according to still another aspect is a storage medium that stores a computer program to be executed by a computer to perform at least: cause one or more control devices to recognize a vicinity situation of a vehicle, control steering and acceleration or deceleration of the vehicle on the basis of the recognized vicinity situation, determine whether the vehicle may enter a specific parking facility in which vehicles autonomously park, determine whether the vehicle is a vehicle that can enter the specific parking facility, and notify an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

(16): An information providing method according to still another aspect is an information providing method in which one or more information providing devices determine whether a vehicle that controls steering and acceleration or deceleration of the vehicle may enter a specific parking facility in which vehicles autonomously park on the basis of a vicinity situation recognized by a vicinity situation recognizer that is configured to recognize the vicinity situation of the vehicle, determine whether the vehicle is a vehicle that can enter the specific parking facility, and notify an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

(17): A non-transitory computer-readable storage medium according to still another aspect is a storage medium that stores a computer program to be executed by a computer to perform at least: cause one or more information providing devices to determine whether a vehicle that controls steering and acceleration or deceleration of the vehicle may enter a specific parking facility in which vehicles autonomously park on the basis of a vicinity situation recognized by a vicinity situation recognizer that is configured to recognize the vicinity situation of the vehicle, to determine whether the vehicle is a vehicle that can enter the specific parking facility, and to notify an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

According to (1) to (17), it is possible to allow the user to recognize that a predetermined parking lot cannot be used in advance.

According to (4), (9), and (13), notification is performed at an appropriate timing by adding an equipment provided in a facility.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram which schematically shows a scene in which an autonomous parking event is executed.

FIG. 4 is a diagram which shows an example of a configuration of a parking lot management device.

FIG. 5 is a diagram which shows an example of content of vehicle information.

FIG. 6 is a diagram which shows an example of a scene in which notification processing is performed.

FIG. 7 is a diagram which shows an example of information notified to an occupant.

FIG. 8 is a flowchart which shows an example of a flow of processing executed by an automated driving control device.

FIG. 9 is a diagram which shows an example of a scene in which an information provider of a second embodiment performs notification.

FIG. 10 is a diagram which shows an example of information notified to an occupant.

FIG. 11 is a flowchart which shows an example of a flow of processing executed by an automated driving control device of the second embodiment.

FIG. 12 is a flowchart which shows an example of a flow of processing executed by an automated driving control device of a third embodiment.

FIG. 13 is a diagram which shows an example of a configuration of a parking lot management device of a fourth embodiment.

FIG. 14 is a diagram which shows an example of content of a parking space state table.

FIG. 15 is a flowchart which shows an example of a flow of processing executed by a host vehicle M and the parking lot management device.

FIG. 16 is a diagram which shows an example of a configuration of a parking lot management device of a fifth embodiment.

FIG. 17 is a flowchart which shows an example of a flow of processing executed by the host vehicle M and the parking lot management device.

FIG. 18 is a diagram which shows an example of a functional configuration of an information providing device.

FIG. 19 is a diagram which shows an example of content of parking lot information of a sixth embodiment.

FIG. 20 is a sequence diagram which shows an example of a flow of processing executed by a vehicle and an information providing device.

FIG. 21 is a diagram which schematically shows a scene in which an autonomous parking event of a seventh embodiment is executed.

FIG. 22 is a diagram which shows an example of a hardware configuration of an automated driving control device of the embodiments.

### DETAILED DESCRIPTION

Hereinafter, embodiments of a vehicle control device, an information providing system, a vehicle control method, an information providing method, and a storage medium will be described with reference to the drawings.

### First Embodiment

[Overall Configuration]

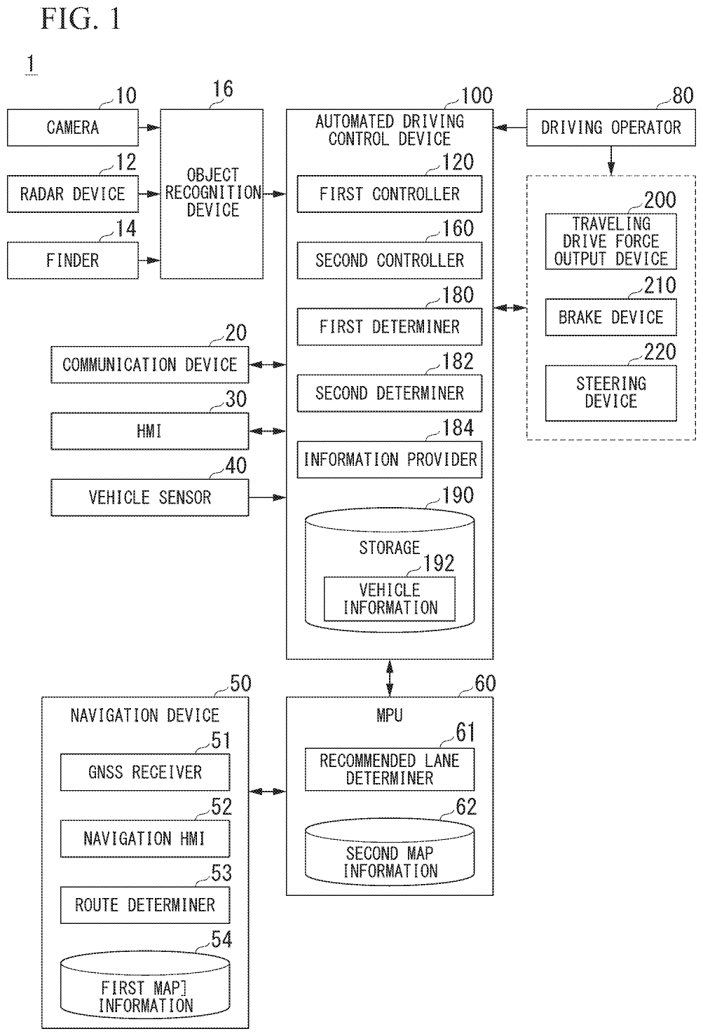

FIG. 1 is a configuration diagram of a vehicle system 1 using a vehicle control device according to an embodiment. A vehicle on which the vehicle system 1 is mounted is, for example, a two-wheel, three-wheel, or four-wheel vehicle, and a driving source thereof is an internal combustion engine such as a diesel engine or a gasoline engine, an electric motor, or a combination of these. The electric motor operates using electric power generated by a generator connected to the internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and some of the configuration may be omitted or another configuration may be further added.

The camera 10 is a digital camera using a solid-state imaging sensor such as a charge coupled device (CCD) or a complementary metal oxide semiconductor (CMOS). The camera 10 is attached to an arbitrary place of a vehicle (hereinafter, a host vehicle M) on which the vehicle system 1 is mounted. When the front is imaged, the camera 10 is attached to an upper part of the front windshield, a rear surface of the windshield rearview mirror, or the like. The camera 10 captures an image of a vicinity of the host vehicle M periodically and repeatedly. The camera 10 may also be a stereo camera.

The radar device 12 emits radio waves such as millimeter waves to the vicinity of the host vehicle M and detects radio waves (reflected waves) reflected by an object to detect at least a position (distance and orientation) of the object. The radar device 12 is attached to an arbitrary place of the host vehicle M. The radar device 12 may detect a position and a speed of the object using a frequency modulated continuous wave (FM-CW) method.

The finder 14 is a light detection and ranging (LIDAR). The finder 14 emits light to the vicinity of the host vehicle M and measures scattered light. The finder 14 detects a distance to the object on the basis of time from light emission to light reception. The emitted light is, for example, a pulsed laser beam. The finder 14 is attached to an arbitrary place of the host vehicle M.

The object recognition device 16 performs sensor fusion processing on results of detection by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may also be omitted from the vehicle system 1.

The communication device 20 uses, for example, a cellular network, a Wi-Fi network, a Bluetooth (registered trademark), a dedicated short range communication (DSRC), or the like, and communicates with another vehicle or a parking lot management device (to be described below) existing in the vicinity of the host vehicle M or various server devices.

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects an acceleration, a yaw rate sensor that detects an angular speed around a vertical axis, an orientation sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M identified by the GNSS receiver 51 (or an arbitrary input position) to a destination input by the occupant using the navigation HMI 52 (hereinafter, a route on a map) with reference to the first map information 54. The first map information 54 is, for example, information in which a road shape is expressed by a link indicating a road and nodes connected by the link. The first map information 54 may include a curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smartphone or a tablet terminal carried by the occupant. The navigation device 50 may transmit a current position and a destination to a navigation server via the communication device 20, and acquire the same route as the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle proceeding direction), and determines a recommended lane for each block with reference to the second map information 62. The recommended lane determiner 61 determines which lane from the left to travel. When a branch place is present in the route on a map, the recommended lane determiner 61 determines a recommended lane such that the host vehicle M can travel in a reasonable route for proceeding to the branch destination.

The second map information 62 is map information with higher accuracy than the first map information 54. The second map information 62 includes, for example, information on a center of a lane, information on a boundary of a lane, or the like. The second map information 62 may include road information, traffic regulation information, address information (addresses and postal codes), facility information, telephone number information, and the like. The second map information 62 may be updated at any time by the communication device 20 communicating with another device.

The driving operator 80 includes, for example, accelerator pedals, brake pedals, shift levers, steering wheels, modified steering, joysticks, and other operators. A sensor that detects an amount of operation or a presence or absence of an operation is attached to the driving operator 80. A result of the detection is output to the automated driving control device 100, or some or all of the traveling drive force output device 200, the brake device 210, and the steering device 220.

The automated driving control device 100 includes, for example, a first controller 120, a second controller 160, a first determiner 180, a second determiner 182, an information provider 184, and a storage 190.

The first controller 120, the second controller 160, the first determiner 180, the second determiner 182, and the information provider 184 are realized by, for example, a hardware processor such as a central processing unit (CPU) executing a program (software). Some or all of these components may be realized by hardware (circuit unit; including circuitry) such as a large scale integration (LSI), an application specific integrated circuit (ASIC), a field-programmable gate array (FPGA), and a graphics processing unit (GPU), or may also be realized by cooperation of software and hardware. The program may be stored in advance in a storage device (storage device including a non-transitory storage medium) such as an HDD or a flash memory of the automated driving control device 100, or may be stored in a detachable storage medium such as a DVD or a CD-ROM and installed in the HDD or the flash memory of the automated driving control device 100 by the storage medium (non-transitory storage medium) being mounted on a drive device.

The storage 190 is realized by an HDD, a flash memory, an electrically erasable programmable read only memory (EEPROM), a read only memory (ROM), a random access memory (RAM), or the like. The storage 190 stores, for example, vehicle information 192 (details will be described below).

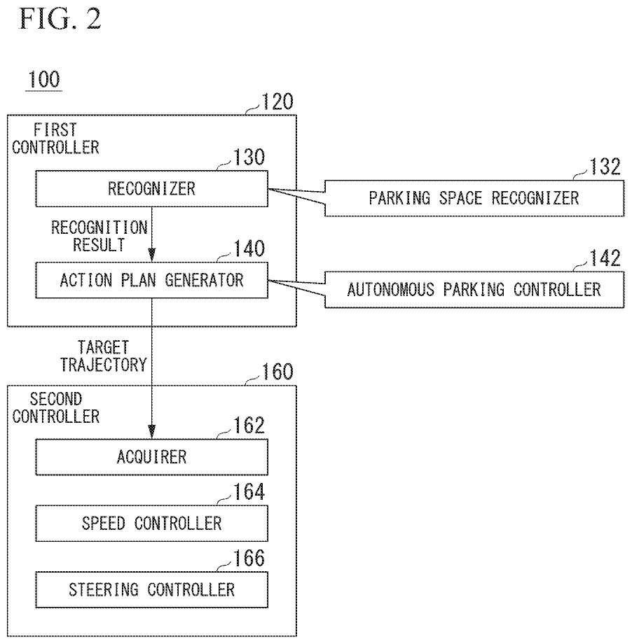

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be may be realized by executing in parallel with recognition of an intersection by deep learning and the like and recognition based on conditions given in advance (such as a signal that can be subjected to pattern matching, a road sign, and the like), and may be realized by scoring both recognition and comprehensively evaluating them. As a result, a reliability of automated driving is secured.

The recognizer 130 recognizes a state such as a position, a speed, an acceleration, and the like of an object in the vicinity of the host vehicle M on the basis of information input from the camera 10, the radar device 12, and the finder 14 via the object recognition device 16. The position of an object is recognized as a position on absolute coordinates with a representative point (a center of gravity, a center of a drive shaft, and the like) of the host vehicle M as an origin, and is used for control. The position of an object may be represented by a representative point such as the center of gravity or a corner of the object, or may be represented by a represented area. The “state” of the object may include an acceleration or jerk of the object, or an “action state” (for example, whether a lane change is being performed or is intended to be performed).

The recognizer 130 recognizes, for example, a lane (traveling lane) in which the host vehicle M is traveling. For example, the recognizer 130 recognizes the traveling lane by comparing a pattern of a road section line (for example, an array of solid lines and dashed lines) obtained from the second map information 62 with a pattern of a road section line in the vicinity of the host vehicle M recognized from an image captured by the camera 10. The recognizer 130 may recognize the traveling lane by recognizing not only a road section line but also a traveling road boundary (road boundary) including the road section line, a road shoulder, a curb, a median strip, a guardrail, and the like. In this recognition, the position of the host vehicle M acquired from the navigation device 50 and a result of processing by the INS may be added. The recognizer 130 recognizes temporary stop lines, obstacles, red lights, toll booths, and other road events.

The recognizer 130 recognizes the position and posture of the host vehicle M with respect to the traveling lane when the traveling lane is recognized. The recognizer 130 may recognize a deviation of a reference point of the host vehicle M from the center of the lane and an angle formed against a line connecting the center of the lane in the proceeding direction of the host vehicle M as a relative position and posture of the host vehicle M with respect to the traveling lane. Instead, the recognizer 130 may recognize a position of the reference point of the host vehicle M or the like with respect to any side end (a road section line or road boundary) of the traveling lane) as the relative position of the host vehicle M with respect to the traveling lane.

The recognizer 130 includes a parking space recognizer 132 that is activated in an autonomous parking event to be described below. Details of functions of the parking space recognizer 132 will be described below.

The action plan generator 140 travels in a recommended lane determined by the recommended lane determiner 61, in principle, and further generates a target trajectory in which the host vehicle M will automatically (independently from an operation of a driver) travel to be able to cope with a vicinity situation of the host vehicle M. The target trajectory includes, for example, a speed element. For example, the target trajectory is expressed as a sequential arrangement of trajectory points to be reached by the host vehicle M. The trajectory points are points to be reached by the host vehicle M every predetermined traveling distance (for example, about several [m]) on a road, and apart from this, a target speed and a target acceleration for each predetermined sampling time (for example, about 0 commas [sec]) are generated as a part of the target trajectory. The trajectory point, for each predetermined sampling time, may be a position to be reached by the host vehicle M at a corresponding predetermined sampling time. In this case, information on the target speed and the target acceleration is expressed by an interval of the trajectory points.

The action plan generator 140 may set an event of automated driving in generating the target trajectory. Examples of the event of automated driving include a constant speed traveling event, a low-speed following traveling event, a lane change event, a branch event, a merging event, a takeover event, an autonomous parking event in which a vehicle parks with automated traveling without depending on an operation of the occupant in valet parking or the like. The action plan generator 140 generates a target trajectory in accordance with an activated event. The action plan generator 140 includes an autonomous parking controller 142 which is activated when the autonomous parking event is executed. Details of functions of the autonomous parking controller 142 will be described below.

The second controller 160 controls the traveling drive force output device 200, the brake device 210, and the steering device 220 such that the host vehicle M passes through a target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (trajectory point) generated by the action plan generator 140, and causes it to be stored in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. The processing performed by the speed controller 164 and the steering controller 166 is, for example, realized by a combination of feed forward control and feedback control. As an example, the steering controller 166 executes a combination of the feed forward control in accordance with a curvature of a road ahead of the host vehicle M and the feedback control based on a deviation from the target trajectory.

Details of the processing of the first determiner 180, the second determiner 182, and the information provider 184 will be described below.

The traveling drive force output device 200 outputs a traveling drive force (torque) for traveling of the vehicle to drive wheels. The traveling drive force output device 200 includes, for example, a combination of an internal combustion engine, an electric motor, a transmission, and the like, and an electronic control unit (ECU) for controlling these. The ECU controls the constituents described above according to information input from the second controller 160 or information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls an electric motor according to the information input from the second controller 160 and the information input from the driving operator 80, and outputs a brake torque in accordance with a braking operation to each vehicle wheel. The brake device 210 may include, as a backup, a mechanism that transmits a hydraulic pressure generated by an operation of a brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes, for example, a direction of steering wheels by, for example, applying a force to a rack and pinion mechanism. The steering ECU drives the electric motor and changes a direction of the steering wheels according to the information input from the second controller 160 or the information input from the driving operator 80.

[Autonomous Parking Event—at the Time of Entrance]

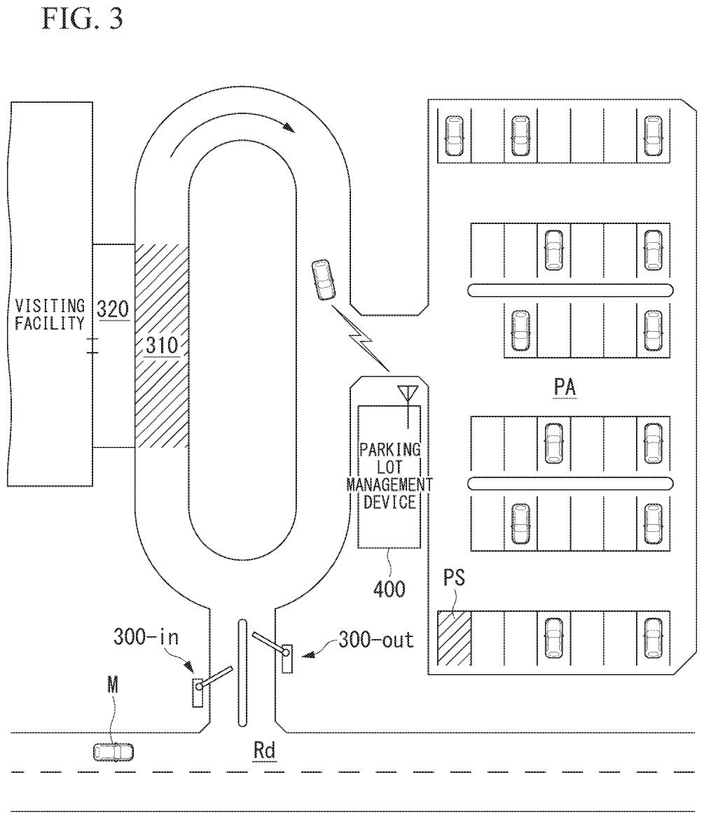

The autonomous parking controller 142 causes, for example, the host vehicle M to park in a parking space on the basis of the information acquired from the parking lot management device 400 by the communication device 20. FIG. 3 is a diagram which schematically shows a scene in which the autonomous parking event is executed. In a route from a road Rd to a visiting destination facility, gates 300-in (an entrance reference point that is a reference for entering a specific packing facility) and 300-out are provided. The host vehicle M passes through the gate 300-in and proceeds to the stop area 310 by manual driving or automated driving. The stop area 310 faces a getting-on/off area 320 connected to the visiting destination facility. The getting-on/off area 320 is provided with an eave to avoid rain and snow.

The host vehicle M stops at the stop area 310, performs automated driving in an unmanned manner (or in a manned manner) after the occupant has got off at the getting-on/off area 320, and starts the autonomous parking event that the vehicle moves to a parking space PS in a parking lot PA. the parking lot PA is, for example, a parking lot dedicated to vehicles parking in parking spaces by automated traveling. The parking lot PA is, for example, a parking lot which is not available for vehicles parking in parking spaces by traveling in manual driving. The “parking lot PA” is an example of the “specific parking facility.” In the first map information 54 or the second map information 62 (hereinafter, these may be referred to as map information), information indicating whether a parking lot is the parking lot dedicated to vehicles parking in parking spaces by automated traveling is associated with identification information or position information of a parking lot. Facilities in FIG. 3 may include a parking lot in which vehicle parking is performed by manual driving in addition to the parking lot PA.

A start trigger of the autonomous parking event may be, for example, any operation by the occupant, or may be a reception of a predetermined signal wirelessly from the parking lot management device 400. The autonomous parking controller 142 transmits a parking request to the parking lot management device 400 by controlling the communication device 20 when the autonomous parking event is started. Then, the host vehicle M moves from the stop area 310 to the parking lot PA according to a guidance of the parking lot management device 400 or while sensing by itself.

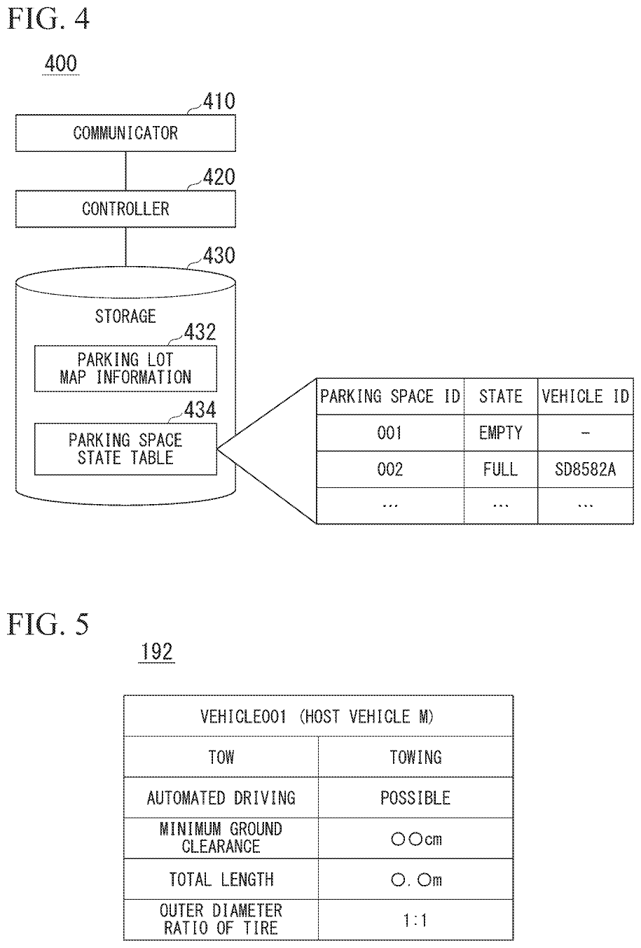

FIG. 4 is a diagram which shows an example of the configuration of the parking lot management device 400. The parking lot management device 400 includes, for example, a communicator 410, a controller 420, and a storage 430. The storage 430 stores information such as parking lot map information 432 and information on a parking space state table 434.

The communicator 410 wirelessly communicates with the host vehicle M and other vehicles. The controller 420 guides a vehicle to a parking space PS on the basis of information acquired by the communicator 410 and information stored in the storage 430. The parking lot map information 432 is information that geometrically represents a structure of a parking lot PA. The parking lot map information 432 includes coordinates for each parking space PS. The parking space state table 434 includes, for example, a state indicating whether a parking space PS is in an empty state or a full state (parking) and a vehicle ID that is identification information of a parking vehicle in the full state are associated with a parking space ID that is identification information of a parking space PS.

If the communicator 410 receives a parking request from a vehicle, the controller 420 extracts a parking space PS whose state is an empty state with reference to the parking space state table 434, acquires a position of the extracted parking space PS from the parking lot map information 432, and transmits a suitable route to the acquired position of the parking space PS to the vehicle using the communicator 410. The controller 420 instructs an identified vehicle to stop, slow down, or the like when necessary on the basis of a positional relationship of a plurality of vehicles such that the vehicles do not proceed to the same place at the same time.

In a vehicle which has received a route (hereinafter, referred to as the host vehicle M), the autonomous parking controller 142 generates a target trajectory based on the route. If a target parking space PS is approached, the parking space recognizer 132 recognizes a parking frame line and the like that partition the parking space PS, and recognizes a detailed position of the parking space PS to provide it to the autonomous parking controller 142. The autonomous parking controller 142 corrects the target trajectory by receiving it, and causes the host vehicle M to park in the parking space PS.

[Autonomous Parking Event—at the Time of Exit]

The autonomous parking controller 142 and the communication device 20 maintain an operation state even when the host vehicle M is parked. The autonomous parking controller 142 causes a system of the host vehicle M to be activated and causes the host vehicle M to move to the stop area 310 when, for example, the communication device 20 has received a pick-up request from a terminal device of the occupant. At this time, the autonomous parking controller 142 controls the communication device 20 and transmits a start request to the parking lot management device 400. The controller 420 of the parking lot management device 400, like at the time of entrance, instructs an identified vehicle to stop, slow down, or the like when necessary on the basis of the positional relationship of a plurality of vehicles such that the vehicles do not proceed to the same place at the same time. If the host vehicle M is moved to the stop area 310 and causes the occupant to get thereon, the autonomous parking controller 142 stops operating, and thereafter, manual driving or automated driving by another functional unit is started.

Not limited to the description described above, the autonomous parking controller 142, independently from communication, may find an empty parking space by itself on the basis of a result of detection by the camera 10, the radar device 12, the finder 14, or the object recognition device 16, and cause the host vehicle M to park in the found parking space.

The first determiner 180 determines whether the host vehicle M may enter the parking lot PA in which vehicles autonomously park. For example, the first determiner 180 determines that the host vehicle may enter the parking lot PA when one or more conditions among the following conditions (1) to (3) are satisfied.

(1) The destination of a vehicle is set to the parking lot PA or a facility having the parking lot PA in the navigation device 50. The facility having the parking lot PA is, for example, a facility that manages the parking lot PA like a department store that manages the parking lot PA, a facility affiliated with the parking lot PA, or the like.

(2) The occupant has operated a direction indicator of the vehicle to indicate an intention to enter the parking lot PA at a predetermined distance before the parking lot PA. The occupant has performed an operation of blinking a left direction indicator of the vehicle when the vehicle reaches a predetermined distance before the parking lot PA when the vehicle is traveling in the road Rd.

(3) The occupant of the vehicle has controlled the vehicle such that the vehicle approaches a side near the parking lot PA of a lane when the condition (1) or (2) described above is satisfied and the vehicle is traveling in the road Rd.

When it is determined that the host vehicle may enter a parking lot, the first determiner 180 refers to the position information of the host vehicle M and the map information, and determines whether the parking lot which is determined that there is a possibility that the host vehicle may enter is the parking lot dedicated to vehicles parking in parking spaces by automated traveling. Then, when the parking lot is such a specific parking lot, the second determiner 182 performs the following processing.

The second determiner 182 determines whether the host vehicle is a vehicle that can enter the parking lot PA. The second determiner 182 refers to the vehicle information 192 stored in the storage 190 and determines whether the host vehicle M satisfies conditions for entering the parking lot PA.

FIG. 5 is a diagram which shows an example of content of the vehicle information 192. The vehicle information 192 includes, for example, information indicating whether the host vehicle M is a towing vehicle, information indicating whether the host vehicle is a vehicle capable of performing automated driving, information indicating a minimum ground clearance of the host vehicle M, information indicating a total length of the host vehicle M, information indicating an outer diameter ratio of a tire, and the like. The minimum ground clearance is a vertical distance from a horizontal ground surface to a lowest point (for example, a fender) of the vehicle body. Some of these types of information may be omitted.

For example, the host vehicle M may recognize that a trailer T is being towed on the basis of a result of detection by a detector that detects that a connection part of the trailer and a connection part of the vehicle are connected. Each piece of the information described above may be acquired on the basis of an operation of the HMI 30 performed by the occupant or the like. The second determiner 182 may refer to a result of detecting of an air pressure sensor that detects an air pressure of the tire, and derive an outer diameter ratio of the tire.

The second determiner 182 compares the vehicle information 192 with the setting conditions for entering the parking lot PA, and determines that the host vehicle M can enter the parking lot PA when the vehicle information 192 satisfies the setting conditions. Vehicles that do not satisfy the setting conditions include, for example, at least one or more conditions of towing vehicles, vehicles that do not have a function of automated driving, vehicles whose minimum ground clearances are equal to or less than a set minimum ground clearance, or vehicles that have different outer diameters of the left and right tires (vehicles whose outer diameter ratios are different by a predetermined degree or more). The setting conditions are not limited to the above description, and may be conditions related to specifications, elements, or the like of vehicles, which are different from the empty state of the parking lot.

The second determiner 182 may refer to the setting conditions of each parking lot, and determines that the host vehicle M is a vehicle which can enter the parking lot PA when the vehicle information 192 satisfies the setting conditions. The second determiner 182 may refer to the setting conditions of each parking lot associated with the identification information of a parking lot of the map information or the setting conditions of a parking lot acquired from another device as described in a third embodiment described below, and determine that the host vehicle M is a vehicle that can enter the parking lot PA.

When the first determiner 180 has determined that the host vehicle M may enter the parking lot PA and the second determiner 182 has determined that the host vehicle M does not satisfy the conditions for entering the parking lot PA, the information provider 184 notifies the occupant that entrance to the parking lot PA is inappropriate before the host vehicle M enters the parking lot PA. The term of “inappropriate” means that the host vehicle M cannot park in the parking lot PA. In the following description, this processing is referred to as “notification processing.”

[Notification Processing]

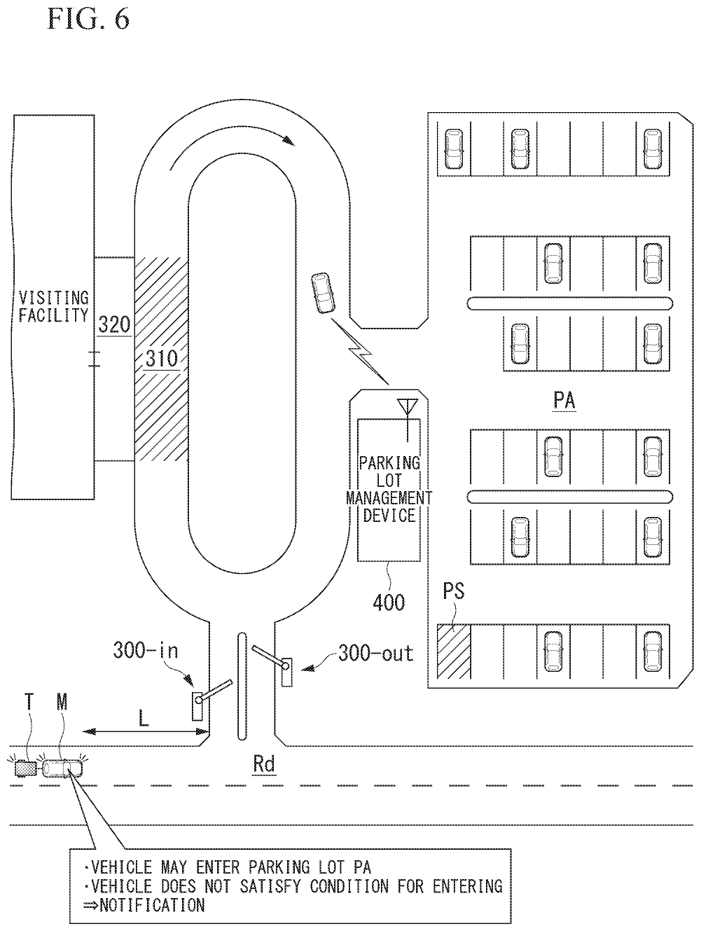

FIG. 6 is a diagram which shows an example of a scene in which the notification processing is performed. Description of the same content as in FIG. 3 will be omitted. In the example of FIG. 6, it is assumed that the host vehicle M is towing the trailer T and it is recognized that the trailer T is being towed. Then, the setting condition is a vehicle which is not a towing vehicle. It is assumed that the host vehicle M satisfies the other setting conditions.

For example, when the first determiner 180 has determined that the condition of (2) described above is satisfied and the second determiner 182 has further determined that the host vehicle M is a towing vehicle, the occupant is notified that entrance to the parking lot PA is inappropriate before the host vehicle M enters the gate 300-in. The term of “before the host vehicle M enters the gate 300-in” relates to before the host vehicle M turns left to enter the gate 300-in, for example, the host vehicle being near a predetermined distance L from the gate 300-in.

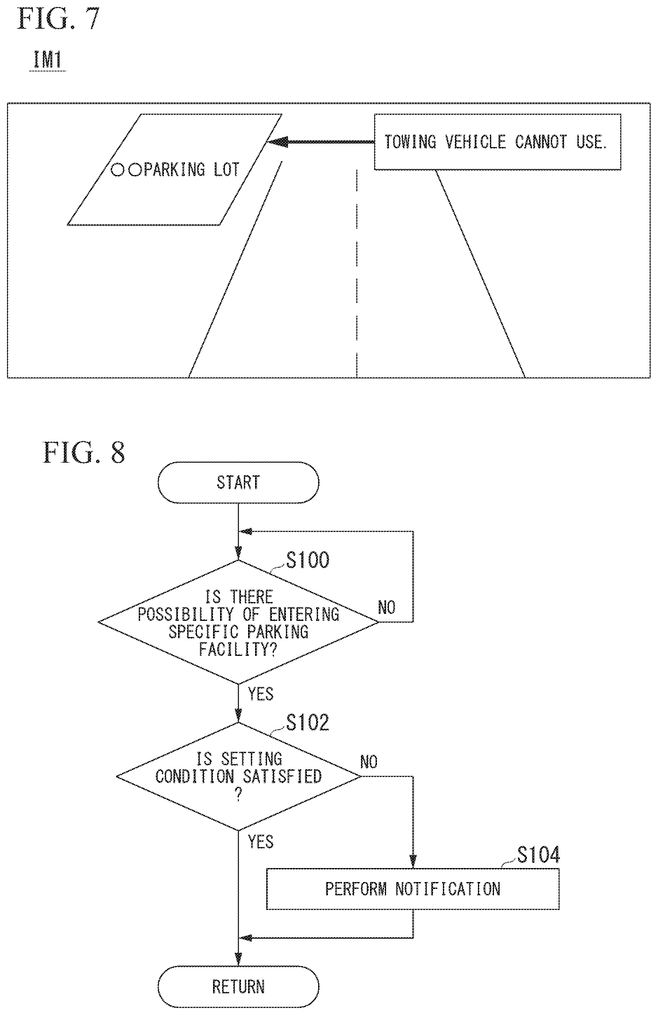

FIG. 7 is a diagram which shows an example of information notified to the occupant. For example, before the host vehicle M enters the parking lot PA, an image IM1 is displayed on a displayer of the HMI 30. For example, a position of the parking lot PA is displayed in the image IM1. The image IM1 includes information indicating that the host vehicle M cannot use the parking lot PA, and the reason for this.

As described above, the information provider 184 performs a notification before the host vehicle M passes through the gate, and thereby it is possible to allow the user to recognize that the predetermined parking lot cannot be used in advance. Then, the occupant can avoid entering the parking lot PA in which the host vehicle M cannot park. As a result, convenience of the user is improved.

[Flowchart]

FIG. 8 is a flowchart which shows an example of a flow of processing executed by the automated driving control device 100. The present processing is, for example, processing executed when the host vehicle M has approached a parking lot stored in the map information. The term of “approaching” means, for example, that the host vehicle M has reached a predetermined distance (a distance longer than the predetermined distance L in FIG. 6) from the parking lot. The present processing is processing that stops when the host vehicle M has passed through the parking lot.

First, the first determiner 180 determines whether the host vehicle M may enter a specific parking facility (step S100). When it is determined that the host vehicle M may enter the specific parking lot, the second determiner 182 determines whether the host vehicle M satisfies the setting conditions for entering the parking lot PA (step S102). When the host vehicle M satisfies the setting conditions for entering the parking lot PA, processing of one routine of the present flowchart ends. When the host vehicle M does not satisfy the setting conditions for entering the parking lot PA, the information provider 184 performs the notification to the occupant (step S104). As a result, the processing of one routine of the present flowchart ends.

According to the first embodiment described above, when a getting-off area at which the occupant of the host vehicle M gets off the vehicle after the vehicle has passed through the gate 300-in is provided in the facility having the parking lot PA, the automated driving control device 100 can allow the user to recognize that a predetermined parking lot cannot be used in advance by performing notification before the host vehicle M passes through the gate 300-in.

Even when the gate 300-in is not provided, processing of the first embodiment may be performed. In this case, notification is performed before the vehicle enters the facility having the parking lot PA from the road Rd (before turning left in the road Rd).

### Second Embodiment

Hereinafter, a second embodiment will be described. In the second embodiment, a notification timing is different from the notification timing of the first embodiment. In the second embodiment, the information provider 184 performs the notification when the host vehicle M has reached or before reaching the getting-off area. In the following description, the second embodiment will be described.

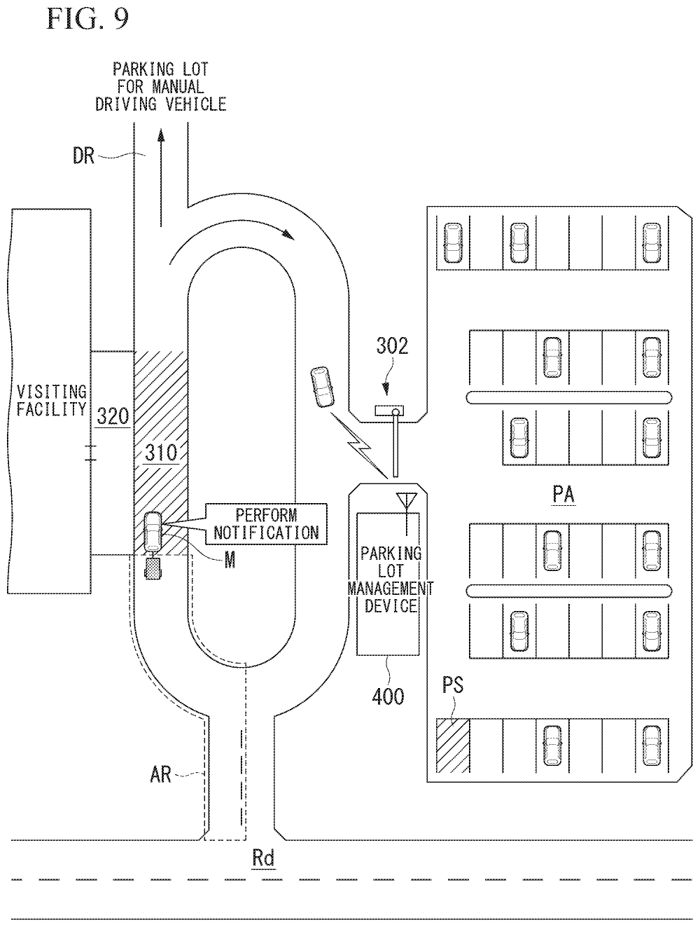

FIG. 9 is a diagram which shows an example of a scene in which the information provider 184 of the second embodiment performs the notification. A difference from in FIG. 6 will be described. In FIG. 9, a parking lot in which vehicles park using manual driving is further included in addition to the parking lot PA in which vehicles park using automated driving. In FIG. 9, the gate 300-in and an exit gate 300-out are omitted, and a gate 302 (entrance reference point) is provided in the vicinity of an entrance or exit of the parking lot PA. The parking lot PA of FIG. 9 is a parking lot in which the vehicle can reach the getting-on/off area 320 at which the occupant of the vehicle gets off the vehicle without passing through the gate.

In the second embodiment, the information provider 184 performs the notification when the host vehicle M has reached or before reaching the stop area 310. The time when it has reached means, for example, when the host vehicle M has entered the stop area 310. The term of “before reaching” means, for example, before (for example, immediately before) the host vehicle M enters the stop area 310 after turning left on the road Rd and entering the parking lot PA. When the host vehicle M is present in an area AR of FIG. 9, the automated driving control device 100 determines that it is “before reaching.”

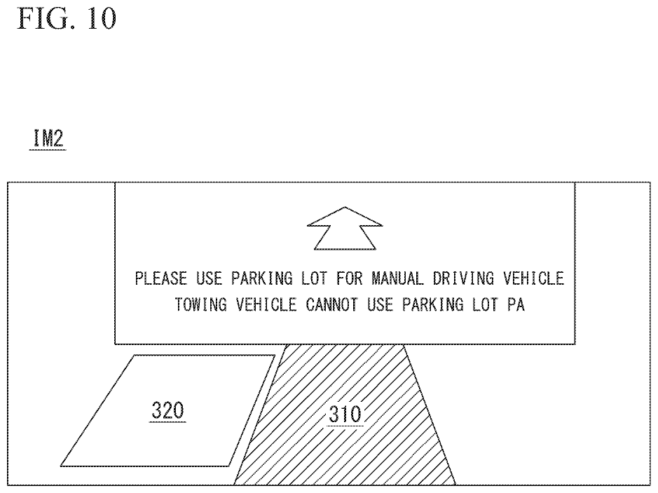

FIG. 10 is a diagram which shows an example of the information notified to the occupant. For example, when the host vehicle M has arrived at the stop area 310, an image IM2 is displayed on the displayer of the HMI 30. For example, the stop area 310 and the getting-on/off area 320 are displayed in the image IM2. The image IM1 includes information indicating that the host vehicle M cannot use the parking lot PA and the reason. The reason is a reason indicating that the vehicle is an inappropriate vehicle for use of the parking lot PA. The map information of parking facilities may be included in the map information, and may be provided from the parking lot management device 400.

As described above, the information provider 184 performs the notification when the host vehicle has reached or before reaching the getting-off area, and thereby it is possible to allow the user to recognize that a predetermined parking lot cannot be used in advance.

[Flowchart]

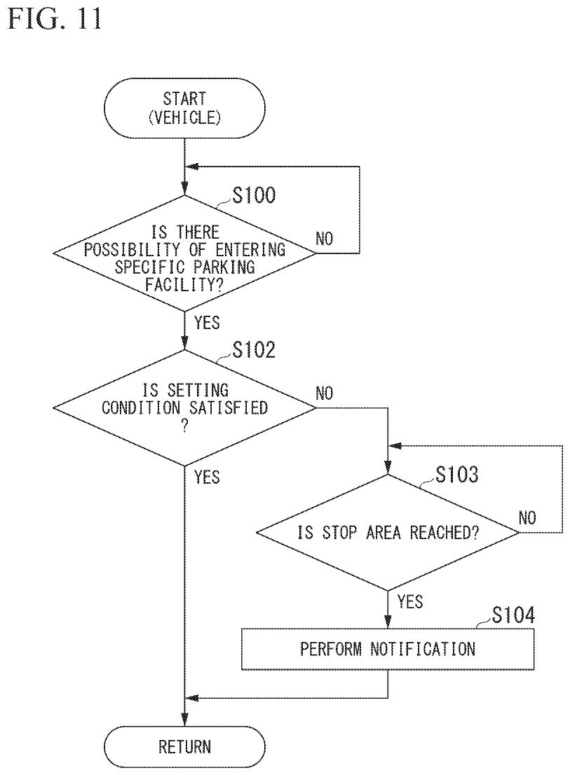

FIG. 11 is a flowchart which shows an example of a flow of processing executed by the automated driving control device 100 of the second embodiment. The present processing is processing in a case in which notification is performed when the host vehicle has reached the stop area 310. A timing at which the present processing is started may also be a timing when the host vehicle M has approached the parking lot stored in the map information, and may also be a timing at which the host vehicle has reached a point at a predetermined distance from the stop area 310 of the parking lot.

Since processing of steps S100, S102, and S104 in the flowchart of FIG. 11 is the same as the processing of steps S100, S102, and S104 in the flowchart of FIG. 8, description thereof will be omitted. In the step S100 of FIG. 11, the first determiner 180 may determine that the host vehicle M may enter the parking lot PA when it is determined that the host vehicle has entered the facility having the parking lot PA (for example, when it is determined that the vehicle has entered the area AR after turning left on the road Rd) instead of the determinations (1) to (3) described above.

When the host vehicle M does not satisfy the setting conditions for entering the parking lot PA, the information provider 184 determines whether the host vehicle M has arrived at the stop area 310 (step S103). When the host vehicle M has arrived at the stop area 310, the information provider 184 performs the notification to the occupant. When the host vehicle M has passed through the parking lot without entering the parking lot PA, the present processing stops. When the host vehicle M has passed the parking lot without entering the parking lot PA, for example, the host vehicle proceeds on the road Rd as it is, or enters once the facility having the parking lot PA and immediately exits. As a result, processing of one routine of the present flowchart ends.

According to the second embodiment described above, when the automated driving control device 100 may reach the stop area 310 at which the occupant of the host vehicle M gets off the vehicle without passing through the gate 302 in the facility having the parking lot PA, the automated driving control device 100 performs the notification when the host vehicle M has reached or before reaching the stop area 310, and thereby it is possible to allow the user to recognize that a predetermined parking lot cannot be used in advance.

Even if the gate 300-in is provided as shown in FIG. 3 described above, the processing of the second embodiment may also be performed. In this case, the gate 302 corresponds to an “entrance gate.”

### Third Embodiment

Hereinafter, a third embodiment will be described. In the third embodiment, the automated driving control device 100 determines a timing for performing notification on the basis of information on the facility having the parking lot PA. In the following description, a difference from the first embodiment and the second embodiment will be described.

The first determiner 180 determines whether the facility having the parking lot PA is a facility provided with a getting-off area at which the occupant of the vehicle gets off the vehicle after the vehicle passes through the gate or whether the facility having the parking lot PA is a facility in which the vehicle can reach the getting-off area at which the occupant of the vehicle gets off the vehicle without passing through the gate. The information provider 184 changes the timing for performing notification on the basis of a result of the determination performed by the first determiner.

The information provider 184 performs the notification at a first timing when the facility having the parking lot PA is the facility provided with the getting-on/off area 320 at which the occupant of the vehicle gets off the vehicle after the vehicle passes through the gate 300-in, and performs the notification at a second timing when the facility having the parking lot PA is the facility in which the vehicle can reach the getting-on/off area 320 at which the occupant of the vehicle gets off the vehicle without passing through the gate 302.

The second timing is a timing that is later than the first timing. The first timing is, for example, a timing before the vehicle passes through the gate. The second timing is, for example, a timing when the vehicle has reached or before reaching the getting-off area.

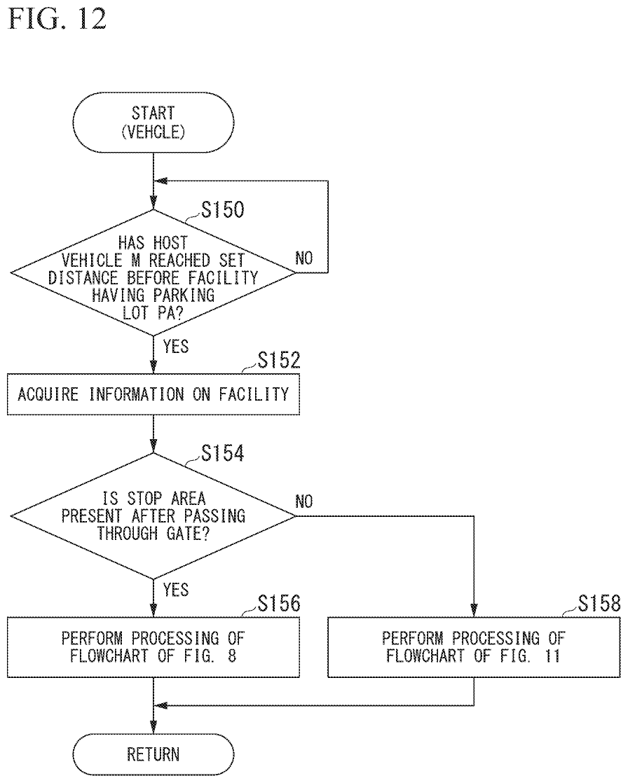

FIG. 12 is a flowchart which shows an example of a flow of processing executed by the automated driving control device 100 of the third embodiment. The first determiner 180 determines whether the host vehicle M has reached a set distance before the facility having the parking lot PA stored in the map information (step S150). When the host vehicle M has reached the set distance before the facility, the first determiner 180 acquires information on the facility (step S152). The information on the facility is information indicating that the stop area 310 (getting-on/off area 320) is present after the vehicle passes through the gate or information indicating that the stop area 310 (getting-on/off area 320) is present before the vehicle passes through the gate. This information may be associated with the identification information of the facility in the map information in advance, and may be acquired from another terminal device (for example, the parking lot management device 400).

Next, the first determiner 180 determines whether the stop area 310 (getting-on/off area 320) is present after the vehicle passes through the gate (step S154). When the stop area 310 is present after the vehicle passes through the gate, the automated driving control device 100 executes processing of the flowchart of FIG. 8 (step S156). When the stop area 310 is present before the vehicle passes through the gate, the automated driving control device 100 executes processing of the flowchart of FIG. 11 (step S158).

According to the third embodiment described above, the automated driving control device 100 determines a timing for performing notification on the basis of the information on the facility having the parking lot PA, and thereby it is possible to perform the notification at an appropriate timing. The processing of the third embodiment may be applied to processing of a fourth embodiment or a fifth embodiment described below.

### Fourth Embodiment

Hereinafter, a fourth embodiment will be described. In the fourth embodiment, the automated driving control device 100 determines whether to perform the notification using the information provided by the parking lot management device 400A. In the following description, a difference from the second embodiment will be mainly described.

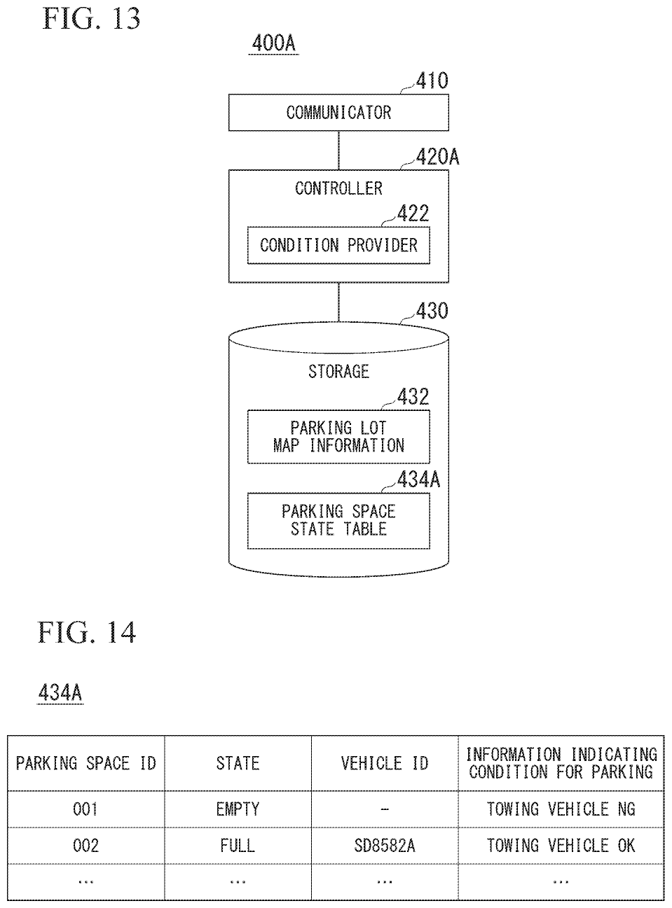

FIG. 13 is a diagram which shows an example of the configuration of the parking lot management device 400A according to the fourth embodiment. The parking lot management device 400A includes a controller 420A instead of the controller 420, and a parking space state table 434A instead of the parking space state table 434. The controller 420A includes a condition provider 422. The condition provider 422 provides information on a parking lot managed by the parking lot management device 400A in response to a request from the automated driving control device 100. The information on a parking lot is, for example, setting conditions and an availability of a parking space.

FIG. 14 is a diagram which shows an example of content of the parking space state table 434A. In the parking space state table 434A, for example, information indicating conditions of a parking available vehicle in a parking space is further associated with a parking space ID in addition to the information included in the parking space state table 434. In the example of FIG. 14, for example, information indicating whether a towing vehicle can stop and the availability of a parking space are associated with the parking space ID.

In the parking space state table 434A, the parking space ID is associated with information indicating conditions for parking, such as a total length of a parking available vehicle, a total combined length of the parking available trailer T and vehicle, or a minimum ground clearance for parking. The parking space ID may be associated with a presence or absence of parking of a vehicle that does not have a function of automatically controlling steering and acceleration or deceleration of the vehicle and a presence or absence of parking of a vehicle and the like that have different outer diameters of the left and right tires.

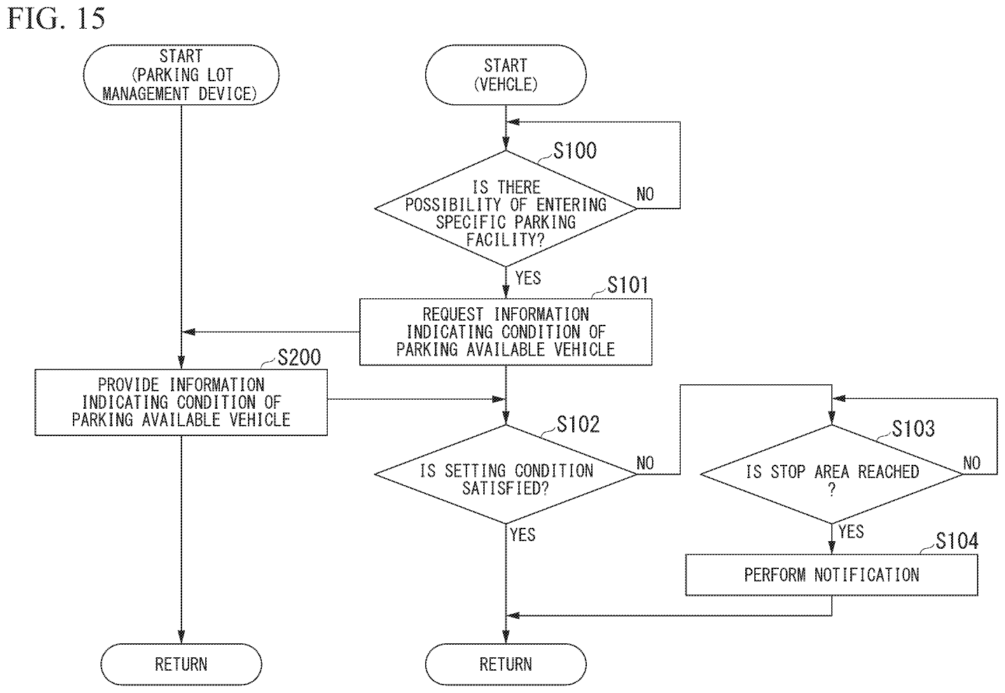

FIG. 15 is a flowchart which shows an example of a flow of processing executed by the host vehicle M and the parking lot management device 400A. Since processing of steps S100, S103, and S104 of FIG. 15 are the same as the processing of steps S100, S103, and S104 of FIG. 11, the description thereof will be omitted.

In step S100, when it is determined that the host vehicle M has entered the facility having the parking lot PA, the second determiner 182 requests the parking lot management device 400A to transmit the information indicating conditions for parking available vehicles (step S101). The parking lot management device 400A refers to the parking space state table 434A and provides the information indicating conditions for parking available vehicles in the parking lot to the vehicle in response to the request transmitted in step S101 (step S200).

Next, the second determiner 182 determines whether the host vehicle M satisfies conditions for entering the parking lot PA on the basis of the information provided in step S200 (step S102), and proceeds to subsequent processing. The second determiner 182 compares a state of the host vehicle M with the information provided in step S102 to determine whether a specific parking lot is a parking lot in which the host vehicle M can park. As a result, processing of one routine of the present flowchart ends.

In the processing described above, the information on parking available vehicles is transmitted to the vehicle, but the availability of the parking lot, a degree of congestion, and the like may be transmitted in addition to the information. The availability of the parking lot is, for example, the availability of a parking space and the like in which an identified vehicle such as a towing vehicle can park. The automated driving control device 100 may perform notification indicating that there is no empty parking space when parking is not possible in the parking space in which the host vehicle M can park. In this case, the information provider 184 may perform a notification that urges the occupant to park in a parking space in which parking is possible by manual driving. By performing the notification in accordance with the availability of a parking space in this manner, the user can easily recognize a parking space in which parking is possible or recognize a parking space in which parking is not possible. As a result, the convenience of the user is improved.

In the present embodiment, processing when it is determined that the vehicle has entered the facility having a specific parking lot has been described, but processing of the present embodiment may also be applied to the processing of performing notification before the vehicle enters the specific parking lot described in the first embodiment. That is, when the facility having the parking lot PA is the facility provided with the getting-off area at which the occupant of the host vehicle M gets off the vehicle after passing through the gate 300-in, the information provider 184 performs the notification before the host vehicle M passes through an entrance gate.

According to the fourth embodiment described above, the same effects as those of the second embodiment can be achieved.

### Fifth Embodiment

Hereinafter, a fifth embodiment will be described. In the fourth embodiment, it is assumed that the automated driving control device 100 determines whether the host vehicle M satisfies the conditions for entering the parking lot PA using the information provided by the parking lot management device 400. In the fifth embodiment, a parking lot management device 400B determines whether the host vehicle M satisfies the conditions for entering the parking lot PA. In the following description, a difference of the fifth embodiment from the fourth embodiment will be mainly described. In the fifth embodiment, the first determiner 180 is an example of a “vehicle-side determiner,” and the information provider 184 is an example of a “vehicle-side provider.” In the fifth embodiment, a condition determiner 426 is an example of a “terminal-side determiner,” and a provider 428 is an example of a “terminal-side provider.”

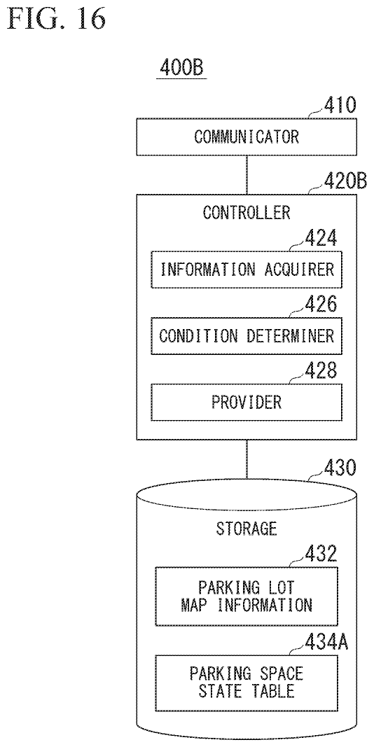

FIG. 16 is a diagram which shows an example of a configuration of the parking lot management device 400B of the fifth embodiment. The parking lot management device 400B includes a controller 420B instead of the controller 420. The controller 420B includes an information acquirer 424, the condition determiner 426, and the provider 428. The information acquirer 424 acquires information transmitted by the automated driving control device 100. The condition determiner 426 determines whether the parking lot PA is a parking lot which the host vehicle M can enter in response to a request of the automated driving control device 100. The provider 428 provides a result of the determination to the host vehicle M.

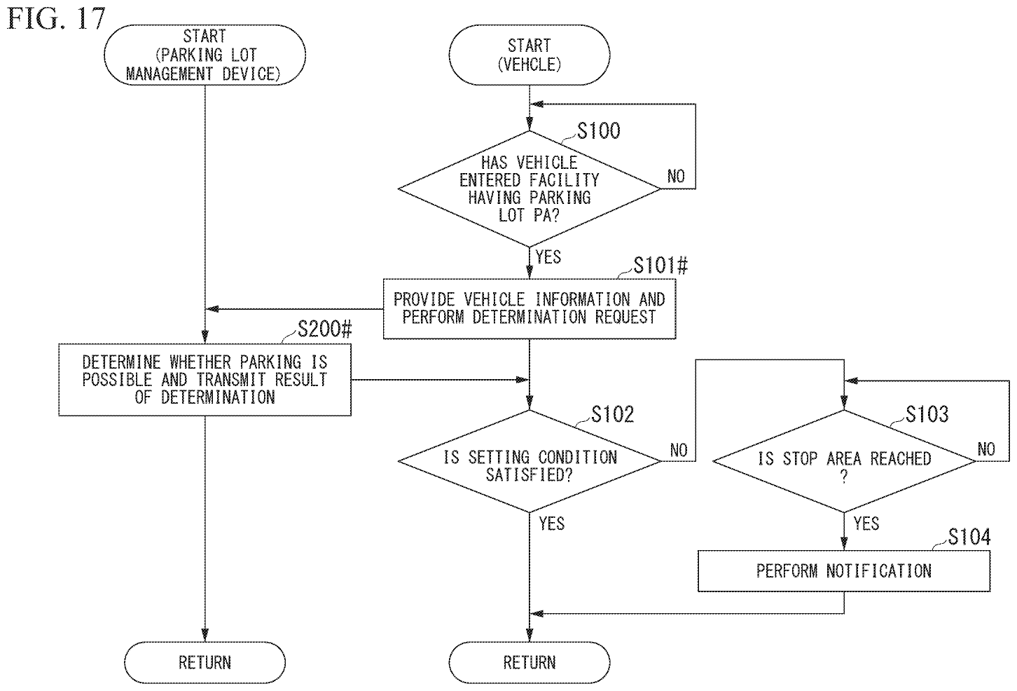

FIG. 17 is a flowchart which shows an example of a flow of processing executed by the host vehicle M and the parking lot management device 400B. Since processing of steps S100, S103, and S104 of FIG. 17 is the same as the processing of steps S100, S103, and S104 of FIG. 11, the description thereof will be omitted.

In step S100, when it is determined that the host vehicle M has entered the facility having the parking lot PA, the second determiner 182 provides the vehicle information 192 of the host vehicle M to the parking lot management device 400B and further requests the parking lot management device 400B to determine whether the parking lot PA is a parking lot in which the host vehicle M can park (step S101#).

The parking lot management device 400B refers to the parking space state table 434A and the vehicle information of the host vehicle M in response to the request transmitted in step S101#, determines whether the parking lot is a parking lot in which the host vehicle M can park, and provides a result of the determination to the vehicle M (step S200#). Next, the second determiner 182 determines whether the host vehicle M satisfies the conditions for entering the parking lot PA on the basis of the information provided in step S200# (step S102), and proceeds to subsequent processing. As a result, processing of one routine of the present flowchart ends.

In the processing described above, the parking lot management device 400B may transmit the availability of the parking lot, the degree of congestion, and the like to the host vehicle M. The availability of the parking lot is, for example, the availability of a parking space and the like in which an identified vehicle such as a towing vehicle can park. As a result, the occupant can recognize the availability of a parking space in which the host vehicle M can park.

In the processing of step S104 of FIG. 17, the parking lot management device 400B may transmit information indicating that there is no empty parking space and information urging to use a parking space in which parking is possible by manual driving when there is no empty parking space in which the host vehicle M can park.

In the present embodiment, the processing when it is determined that the vehicle has entered the facility having the parking lot PA has been described, but the processing of the present embodiment may also be applied to the processing of performing the notification before the vehicle enters the parking lot PA described in the first embodiment. That is, the information provider 184 performs the notification before the host vehicle M passes through the entrance gate when the facility having the parking lot PA is the facility provided with the getting-off area at which the occupant of the host vehicle M gets off the vehicle after the host vehicle M passes through the gate 300-in.

According to the fifth embodiment described above, the parking lot management device 400B determines whether the host vehicle M is in a parking lot in which it can park, thereby reducing a processing load of the automated driving control device 100.

In the fourth and fifth embodiments, an example in which the host vehicle M communicates with the parking lot management device 400B to perform the notification has been described, but the host vehicle M may perform the same processing by communicating with another server device. In this case, the another server device performs the same processing as the processing performed by the parking lot management device described in the fourth and fifth embodiments.

### Sixth Embodiment

Hereinafter, a sixth embodiment will be described. The processing of the notification performed by the host vehicle M described in the first embodiment to the fifth embodiment described above may also be performed by an information providing device.

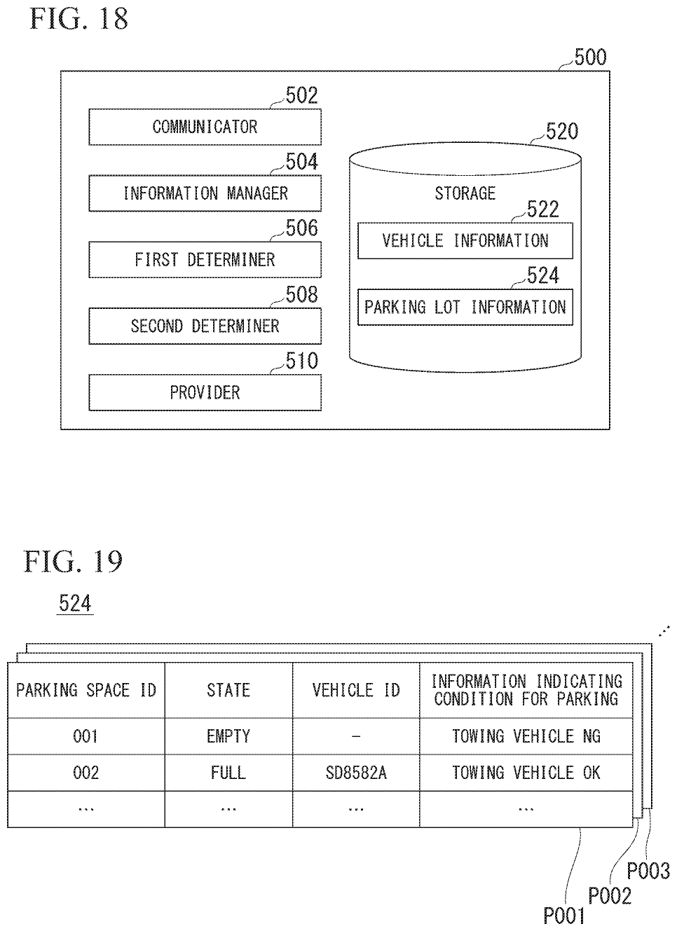

FIG. 18 is a diagram which shows an example of a functional configuration of an information providing device 500. The information providing device 500 includes, for example, a communicator 502, an information manager 504, a first determiner 506, a second determiner 508, a provider 510, and a storage 520. Each of the information manager 504, the first determiner 506, the second determiner 508, and the provider 510 is realized by, for example, a hardware processor such as a CPU executing a program (software). Some or all of these components may be realized by hardware (circuit unit; including circuitry) such as an LSI, an ASIC, an FPGA, and a GPU, and may also be realized by a cooperation of software and hardware. The program may be stored in a storage device such as an HDD or a flash memory of the information providing device 500 in advance, and may be stored in a detachable storage medium such as a DVD or a CD-ROM and installed in the HDD or the flash memory of the information providing device 500 by the storage medium being mounted on a drive device.

The storage 520 stores, for example, vehicle information 522 and parking lot information 524. The vehicle information 522 includes, for example, the vehicle information 192 acquired from each vehicle. FIG. 19 is a diagram which shows an example of content of the parking lot information 524 of the sixth embodiment. The parking lot information 524 includes, for example, a parking lot space state table (the same content as in the parking space state table 434) associated with a plurality of parking lot facilities (P001 to P004).

The communicator 502 is a communication interface that communicates with a vehicle, another terminal device, or the like. The information manager 504 manages information acquired by the communicator 502 communicating with a vehicle, another terminal device, or the like. For example, the information manager 504 causes the storage 520 to store the acquired information.

The first determiner 506 determines whether the host vehicle may enter the parking lot PA in which vehicles autonomously park. The second determiner 508 determines whether the vehicle satisfies conditions for entering the parking lot PA. The provider 510 transmits a result of determination performed by the second determiner 508 to the vehicle, the another terminal device, or the like.

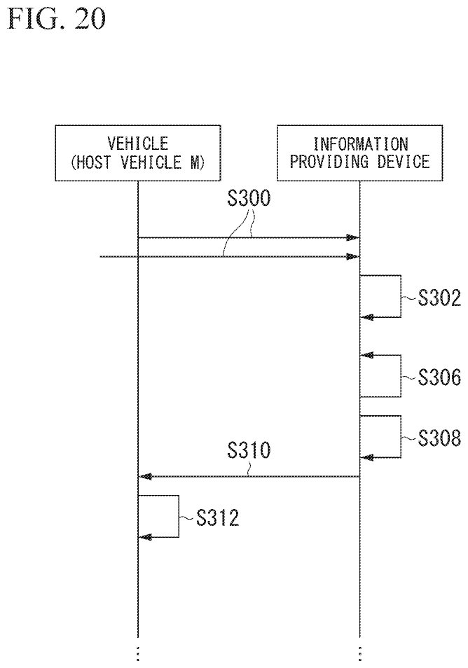

FIG. 20 is a sequence diagram which shows an example of a flow of processing executed by a vehicle and the information providing device 500. First, a vehicle transmits the vehicle information 192, the destination of the vehicle, and the like for each predetermined time (step S300). In the present processing, it is assumed that the destination of the vehicle is the parking lot PA or the facility having the parking lot PA. The information manager 504 of the information providing device 500 acquires the information transmitted in step S300, and causes the storage 520 to store the acquired information (step S302). Next, the vehicle transmits the position information of the vehicle to the information providing device 500 at a predetermined interval (step S304).

Next, the first determiner 506 of the information providing device 500 acquires the position information transmitted in step S304, and determines whether the vehicle has approached the parking lot PA on the basis of the acquired position information and the map information stored in the storage 520 (not shown) (step S306). When the first determiner 506 determines that the vehicle has approached the parking lot PA, the second determiner 508 performs the processing of (A) and (B) to be described below (step S308).

(A) The second determiner 508 determines whether the vehicle can park on the basis of the vehicle information acquired in step S300 and information indicating the setting conditions. (B) The second determiner 508 determines whether a parking space in which a vehicle of interest can park is empty. The parking space in which the vehicle of interest can park is a parking space in which the vehicle of interest having predetermined vehicle information can park, and, for example, if the vehicle of interest is a towing vehicle, the parking space is a parking space in which the towing vehicle can park

When the determination results of (A) and (B) described above are not positive, the provider 510 of the information providing device 500 transmits information indicating that the parking lot PA cannot be used to the vehicle of interest (step S310). The vehicle of interest causes the information transmitted in step S310 to be displayed on a display of the HMI 30 (step S312).

The second determiner 508 may execute the processing of (A) of step S308 after the processing of step S302. When the vehicle of interest is a vehicle which cannot use the parking lot PA, the provider 510 may transmit information indicating that the parking lot PA cannot be used to the vehicle of interest. When the information providing device 500 is a smartphone, a tablet terminal, or the like and has an outputter, it may cause the outputter to output the information indicating that the parking lot PA cannot be used.

The provider 510 may perform the notification before the host vehicle M passes through the gate 300-in when the facility having the parking lot PA is the facility provided with the getting-on/off area 320 at which the occupant of the host vehicle M gets off the vehicle after the host vehicle M passes through the gate 300-in, and perform the notification when the host vehicle M has reached or before reaching the getting-on/off area 320 when the facility having the parking lot PA is the facility in which the vehicle can reach the getting-on/off area 320 at which the occupant of the host vehicle M gets off the vehicle without passing through the gate 302. The same processing as in the third embodiment described above may be performed by the information providing device 500. As a result, the notification is performed to the occupant at an appropriate timing.

According to the sixth embodiment described above, the information providing device 500 performs the notification indicating that entrance to the parking lot PA is inappropriate, thereby allowing the user to recognize that a predetermined parking lot cannot be used in advance.

### Seventh Embodiment

Hereinafter, a seventh embodiment will be described. The predetermined vehicle information described in the first embodiment to fifth embodiment described above may be acquired by a device different from the host vehicle M. In the following description, the seventh embodiment will be described.

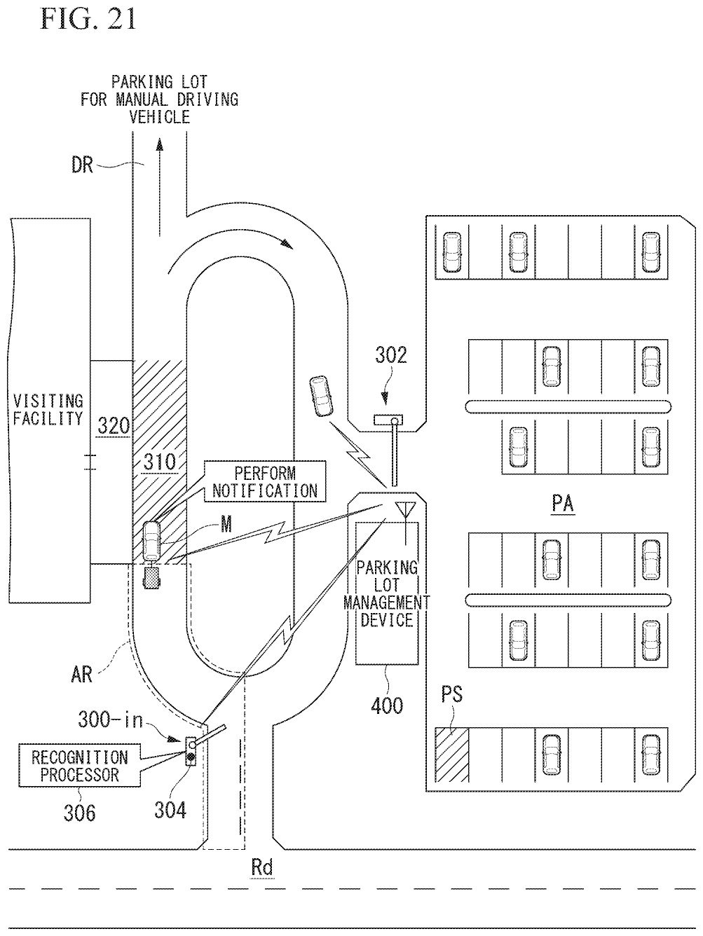

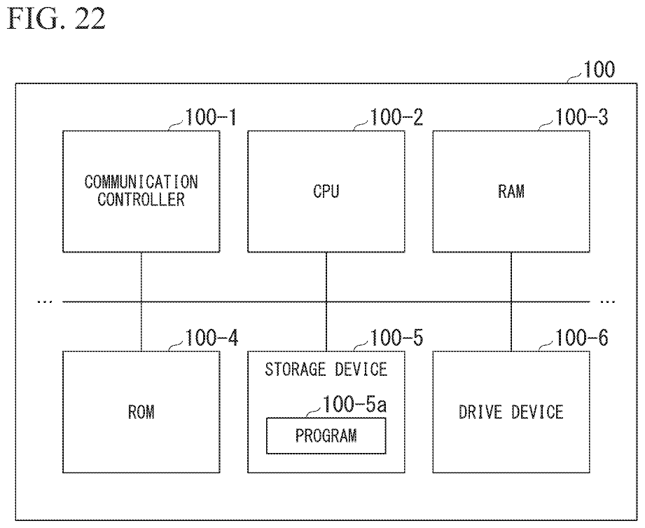

FIG. 21 is a diagram which schematically shows a scene in which an autonomous parking event of the seventh embodiment is executed. A difference from the schematic diagram of FIG. 9 will be described. For example, the gate 300-in is provided at an entrance of the facility. The gate 300-in includes, for example, a camera 304 and a recognition processor 306. The camera 304 captures an image of a vehicle stopped before the gate 300-in to enter the facility. The recognition processor 306 analyzes the image captured by the camera 304 and acquires vehicle information. The vehicle information is the same information as the vehicle information 192 described above. The recognition processor 306 may be provided in another device. In this case, the image captured by the camera 304 is transmitted to a device including the recognition processor 306.

The facility may include one or more cameras in addition to the camera 304. The cameras capture images of the vehicle stopped immediately before the gate 300-in in a plurality of directions. Then, the recognition processor 306 analyzes the images of the vehicle captured by the camera 304 and other cameras, and acquires vehicle information (information indicating a towing vehicle, a minimum ground clearance, a total length, an outer diameter ratio of tires, and the like).

The recognition processor 306 determines that the vehicle associated with the image captured by the camera 304 is a vehicle capable of automated driving when an analysis result of a captured image of a type of vehicle capable of automated driving acquired in advance matches an analysis of the image captured by the camera 304. Then, the gate 300-in transmits a result of the processing performed by the recognition processor 306 to the parking lot management device 400.

The parking lot management device 400 determines whether the vehicle stopped at the gate 300-in can park in the parking lot PA on the basis of the information acquired from the gate 300-in and the information of the parking space state table 434A, and transmits a result of the determination to the vehicle.

According to the seventh embodiment described above, it is possible to allow the user to recognize that a predetermined parking lot cannot be used in advance.

Some or all of the content of each embodiment described above may be appropriately combined and implemented. Some or all of the functional constituents of the vehicle system 1 in each embodiment described above may be included in parking lot management device 400 (400A, 400B) or another terminal device, and some or all of the functional constituents of the parking lot management device 400 (400A, 400B) may also be included in the vehicle system 1 or another terminal device. Some of the functional constituents of the vehicle system 1 or some of the functional constituents of the parking lot management device 400 (400A, 400B) may be omitted. An order of the processing of each flowchart described above may be changed, or some of the processing may be omitted.

In the embodiment described above, the gate 300-in or the gate 302 is described to be provided at the entrance reference point, but the gate 300-in or the gate 302 may be omitted. In this case, for example, when a vehicle passes through the entrance reference point stored in the storage device, the automated driving control device 100 may recognize that the vehicle has entered, and report a result of the recognition to, for example, the parking lot management device 400. The parking lot management device 400 may recognize that the host vehicle M has passed the entrance reference point by the host vehicle M communicating with the parking lot management device 400 when passing through the entrance reference point. An exit reference point may be provided as described above, and settlement processing may be performed.

[Hardware Configuration]

FIG. 21 is a diagram which shows an example of a hardware configuration of the automated driving control device 100 of the embodiment. As shown in FIG. 21, the automated driving control device 100 is configured to include a communication controller 100-1, a CPU 100-2, a random access memory (RAM) 100-3 used as a working memory, a read only memory (ROM) 100-4 that stores a booting program and the like, a storage device 100-5 such as a flash memory or a hard disk drive, a drive device 100-6, and the like connected to one another by an internal bus or a dedicated communication line. The communication controller 100-1 communicates with components other than the automated driving control device 100. The storage device 100-5 stores a program 100-5a executed by the CPU 100-2. This program is developed in the RAM 100-3 by a direct memory access (DMA) controller (not shown) or the like, and is executed by the CPU 100-2. Accordingly, some or all of the first controller 120, the second controller 160, the first determiner 180, the second determiner 182, and the information provider 184 are realized. The parking lot management device 400 and the terminal device 500 also have the configuration shown in FIG. 21, and processing of each functional unit is executed.

The embodiments described above can be expressed as follows.

A vehicle control device is configured to include a storage device which has stored a program, and a hardware processor, by the hardware processing executing the program stored in the storage device, to recognize a vicinity situation of a host vehicle, to control steering and acceleration or deceleration of the host vehicle on the basis of the recognized vicinity situation, to determine whether the host vehicle may enter a specific parking facility in which vehicles autonomously park, to determine whether the host vehicle is a vehicle that can park in the specific parking facility, and to notify an occupant of the vehicle that entrance to the specific parking facility is inappropriate before the host vehicle enters the specific parking facility when it is determined that the host vehicle may enter the specific parking facility and the host vehicle is a vehicle that cannot enter the specific parking facility.

As described above, modes for implementing the present invention have been described using the embodiments, but the present invention is not limited to these embodiments, and various modification and replacement can be made within a range not departing from the gist of the present invention.

What is claimed is:

1. A vehicle control device comprising:
a vicinity situation recognizer configured to recognize a vicinity situation of a vehicle;
a driving controller configured to control steering and acceleration or deceleration of the vehicle on the basis of the vicinity situation recognized by the vicinity situation recognizer;
a first determiner configured to determine whether the vehicle may enter a specific parking facility in which vehicles autonomously park;
a second determiner configured to determine whether the vehicle is a vehicle that can enter the specific parking facility; and
an information provider configured to notify an occupant of the vehicle that entrance to the specific parking facility is inappropriate before the vehicle enters the specific parking facility when the first determiner determines that the vehicle may enter the specific parking facility and the second determiner determines that the vehicle is a vehicle that cannot enter the specific parking facility.

2. The vehicle control device according to claim 1,
wherein, when a facility having the specific parking facility is a facility provided with a getting-off area at which the occupant of the vehicle gets off the vehicle after the vehicle passes through an entrance reference point that is a reference of entrance, the information provider performs the notification before the vehicle passes through the entrance reference point.

3. The vehicle control device according to claim 1,
wherein, when a facility having the specific parking facility is a facility in which the vehicle can reach a getting-off area at which the occupant of the vehicle gets off the vehicle without passing through an entrance reference point that is a reference of entrance, the information provider performs the notification when the vehicle has reached or before reaching the getting-off area.

4. The vehicle control device according to claim 1,
wherein the first determiner is configured to determine whether a facility having the specific parking facility is a facility provided with a getting-off area at which the occupant of the vehicle gets off the vehicle after the vehicle passes through an entrance reference point that is a reference of entrance, and whether the facility having the specific parking facility is the facility in which the vehicle can reach the getting-off area at which the occupant of the vehicle gets off the vehicle without passing through the entrance reference point that is a reference of entrance, and
the information provider is configured to change a timing for performing the notification on the basis of a result of the determination performed by the first determiner.

5. The vehicle control device according to claim 1,
wherein the second determiner is configured to determine a vehicle that tows an object, a vehicle that does not have a function of controlling the steering and acceleration or deceleration thereof, a vehicle whose minimum ground clearance is equal to or less than a set minimum ground clearance, or a vehicle which has different outer diameters of left and right tires thereof as a vehicle which cannot enter the specific parking facility.

6. An information providing device comprising:
a first determiner configured to determine whether a vehicle controlling steering and acceleration or deceleration of the vehicle may enter a specific parking facility in which vehicles autonomously park on the basis of a vicinity situation recognized by a vicinity situation recognizer that is configured to recognize the vicinity situation of the vehicle;
a second determiner configured to determine whether the vehicle is a vehicle that can enter the specific parking facility; and
an information provider configured to notify an occupant of the vehicle that entrance to the specific parking facility is inappropriate before the vehicle enters the specific parking facility when the first determiner determines that the vehicle may enter the specific parking facility and the second determiner determines that the vehicle is a vehicle that cannot enter the specific parking facility.

7. The information providing device according to claim 6,
wherein, when a facility having the specific parking facility is a facility provided with a getting-off area at which the occupant of a vehicle gets off the vehicle after the vehicle passes through an entrance reference point that is a reference of entrance, the information provider performs the notification before the vehicle passes through the entrance reference point.

8. The information providing device according to claim 6,
wherein, when a facility having the specific parking facility is a facility in which a vehicle can reach the getting-off area at which the occupant of the vehicle gets off the vehicle without passing through an entrance reference point that is a reference of entrance, the information provider performs the notification when the vehicle has reached or before reaching the getting-off area.

9. The information providing device according to claim 6,
wherein the first determiner is configured to determine that a facility having the specific parking facility is a facility provided with a getting-off area at which the occupant of a vehicle gets off the vehicle after the vehicle passes through an entrance reference point that is a reference of entrance, or that the facility having the specific parking facility is a facility in which a vehicle can reach a getting-off area at which the occupant of the vehicle gets off the vehicle without passing through the entrance reference point that is a reference of entrance, and
the information provider is configured to change a timing for performing the notification on the basis of a result of the determination performed by the first determiner.

10. An information providing system comprising a terminal device and a vehicle control device:
the terminal device comprises,
a terminal-side determiner configured to determine whether a vehicle is a vehicle that can enter a specific parking facility in accordance with a request from a vehicle control device, and a terminal-side provider configured to provide a result of the determination performed by the terminal-side determiner to the vehicle control device when the terminal-side determiner determines that the vehicle is a vehicle that cannot enter the specific parking facility;
the vehicle control device comprises,
a vicinity situation recognizer configured to recognize a vicinity situation of a vehicle;
a driving controller configured to control steering and acceleration or deceleration of the vehicle on the basis of the vicinity situation recognized by the vicinity situation recognizer; and
a vehicle-side determiner configured to determine whether the vehicle may enter the specific parking facility in which vehicles autonomously park, and, when it is determined that the vehicle may enter the specific parking facility, to request the terminal device to determine whether the vehicle is a vehicle that can enter the specific parking facility, and a vehicle-side provider configured to notify an occupant of the vehicle that entrance to the specific parking facility is inappropriate before the vehicle enters the specific parking facility when it is determined that the vehicle is a vehicle that cannot enter the specific parking facility on the basis of a result of determination provided by the terminal-side provider in accordance with the request.

11. The information providing system according to claim 10,
wherein, when a facility having the specific parking facility is a facility provided with a getting-off area at which the occupant of a vehicle gets off the vehicle after the vehicle passes through an entrance reference point that is a reference of entrance, the vehicle-side provider performs the notification before the vehicle passes through the entrance reference point.

12. The information providing system according to claim 10,
wherein, when a facility having the specific parking facility is a facility in which a vehicle can reach a getting-off area at which the occupant of the vehicle gets off the vehicle without passing through an entrance reference point that is a reference of entrance, the vehicle-side provider performs the notification when the vehicle has reached or before reaching the getting-off area.

13. The information providing system according to claim 10,
wherein the vehicle-side determiner is configured to determine that a facility having the specific parking facility is a facility provided with a getting-off area at which the occupant of a vehicle gets off the vehicle after the vehicle passes through an entrance reference point that is a reference of entrance, or that the facility having the specific parking facility is a facility in which a vehicle can reach a getting-off area at which the occupant of the vehicle gets off the vehicle without passing through the entrance reference point that is a reference of entrance, and
the vehicle-side provider is configured to change a timing for performing the notification on the basis of a result of the determination performed by the vehicle-side determiner.

14. A vehicle control method comprising:
by one or more control devices,
recognizing a vicinity situation of a vehicle,
controlling steering and acceleration or deceleration of the vehicle on the basis of the recognized vicinity situation,
determining whether the vehicle may enter a specific parking facility in which vehicles autonomously park,
determining whether the vehicle is a vehicle that can enter the specific parking facility, and
notifying an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

15. A non-transitory computer-readable storage medium that stores a computer program to be executed by a computer to perform at least:
recognize a vicinity situation of a vehicle,
control steering and acceleration or deceleration of the vehicle on the basis of the recognized vicinity situation,
determine whether the vehicle may enter a specific parking facility in which vehicles autonomously park,
determine whether the vehicle is a vehicle that can enter the specific parking facility, and
notify an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

16. An information providing method comprising:
determining whether a vehicle that controls steering and acceleration or deceleration of the vehicle may enter a specific parking facility in which vehicles autonomously park on the basis of a vicinity situation recognized by a vicinity situation recognizer that is configured to recognize the vicinity situation of the vehicle,
determining whether the vehicle is a vehicle that can enter the specific parking facility, and
notifying an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.

17. A non-transitory computer-readable storage medium that stores a computer program to be executed by a computer to perform at least:
determine whether a vehicle that controls steering and acceleration or deceleration of the vehicle may enter a specific parking facility in which vehicles autonomously park on the basis of a vicinity situation recognized by a vicinity situation recognizer that is configured to recognize the vicinity situation of the vehicle,
determine whether the vehicle is a vehicle that can enter the specific parking facility, and
notify an occupant of the vehicle that entrance to the specific parking facility is inappropriate before the vehicle enters the specific parking facility when it is determined that the vehicle may enter the specific parking facility and that the vehicle is a vehicle that cannot enter the specific parking facility.
